(19) United States
(12) Patent Application Publication
(10) Pub. No.: US 2009/0296238 A1
(43) Pub. Date: Dec. 3, 2009

(54) Lens Apparatus and Image Pickup Apparatus Using the Same

(75) Inventor: Yoshio Kakuta, Saitama-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: TAMRON CO., LTD., Saitama-shi (JP)

(21) Appl. No.: 12/473,770

(22) Filed: May 28, 2009

(30) Foreign Application Priority Data
May 29, 2008 (JP) 2008-140742

(51) Int. Cl. G02B 17/00

(52) U.S. Cl. 359/737

(57) ABSTRACT

This invention has as its object to provide a lens apparatus for an image pickup apparatus which can be reduced in size and is excellent in driving accuracy. In order to achieve the above-described object, this invention adopts a lens apparatus including a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side, wherein the lens group of subject side is fixed to the entrance surface of the prism and/or the lens group of image pickup surface side is fixed to the exit surface of the prism.

### BACKGROUND OF THE INVENTION

1. Field of the Invention

The present invention relates to a lens apparatus and an image pickup apparatus using the lens apparatus.

2. Description of the Related Art

Cellular phones with a single-vision lens have rapidly spread in these years while there are few ones equipped with a zoom lens. Use of a collapsible zoom lens adopted in many digital still cameras in a cellular phone requires an actuator and a mechanical part for extending and retracting a lens system and complicates the configuration of a lens barrel.

Use of an inner zoom mechanism adopted in many digital video cameras requires a certain length in an optical axis direction. If such an inner zoom mechanism is used in a cellular phone, a lens needs to be arranged on a side of the cellular phone. In this case, an optical axis is perpendicular to an LCD display screen of the cellular phone, which decreases ease of use. Although there is available a cellular phone whose LCD display is configured to be rotatable to cause the orientation of the LCD display to coincide with an optical axis, such cellular phones are complicated in pivot mechanism and are expensive. Since a front lens element of a zoom lens is generally large, arrangement of a front lens element on a side increases the thickness of a cellular phone.

For this reason, there has conventionally been proposed an image pickup apparatus capable of reflecting and deflecting a light beam incident from a subject side and causing the reflected and deflected light beam to be emitted toward an image pickup surface side by including a prism (reflective member) and thereby shortening the length of the main body of the apparatus in a horizontal direction.

If a zoom lens including a bending optical system is arranged in a cellular phone, as described above, it is easy to arrange the optical axis of a front lens element of a lens system and an LCD display surface in parallel with each other. Since the front lens element is not arranged in a thickness direction of the cellular phone, the cellular phone can be reduced in thickness. If an entrance surface and an exit surface of a prism are processed with high accuracy, a lens group of subject side arranged on the side of the entrance surface and a lens group of image pickup surface side arranged on the side of the exit surface are arranged such that the optical axis of each lens group is exactly orthogonal to the corresponding surface, the angular accuracy of the optical axis can be kept high.

For example, a Japanese patent application (Japanese Patent Laid-Open No. 9-211287) discloses an image pickup apparatus characterized in that a prism body having an inclined surface which reflects and deflects a light beam as an internal reflection surface is attached on the object side of a photographing system, and an image is picked up via the prism body.

A Japanese patent application (Japanese Patent Laid-Open No. 2006-91405) discloses that a light beam is made incident from a first side surface facing an object of side surfaces of a triangular right angle prism, and the light beam reflected almost at a right angle by a second side surface which is continuous with the first side surface at an acute angle is emitted from a third side surface which is continuous with the first side surface almost at a right angle. The Japanese patent application (Japanese Patent Laid-Open No. 2006-91405) discloses a lens barrel which causes a light beam emitted from the third side surface to focus on a photoelectric conversion element, characterized in that a pedestal frame to which the third side surface is fixed and in which an opening through which a light beam emitted from the third side surface passes is integrally formed with a holding frame in which the right angle prism is incorporated, an image-side lens which receives a light beam emitted from the third side surface is held by the thin-walled lens frame, and the lens frame is fit in the opening such that the image-side lens abuts against the third side surface.

As for a conventional lens apparatus of a bending optical system, optical components constituting the bending optical system are incorporated as one unit in a camera main body. Accordingly, such optical components are generally attached to a single lens barrel. However, in the case of a bending optical system capable of changing a zoom factor by moving a lens group constituting optical components, since attachment adjustment when a lens group which move at the time of changing the zoom factor are attached is difficult, the optical performance of the entire bending optical system cannot be easily kept high. A digital camera including a bending optical system with a high zoom factor has recently been in the mainstream. A higher zoom factor makes it more difficult to keep the optical performance of a bending optical system high.

The image pickup apparatus disclosed in the Japanese patent application (Japanese Patent Laid-Open No. 9-211287) includes the prism body attached thereto and having the inclined surface which reflects and deflects a light beam as the internal reflection surface and picks up an image via the prism body. However, in the technique disclosed in the Japanese patent application (Japanese Patent Laid-Open No. 9-211287), a prism and a lens group of image surface side are positioned via a prism cover and a fixed lens barrel. The members intervening between the prism and the lens group of image surface side make it difficult to keep the optical performance high.

In the lens barrel disclosed in the Japanese patent application (Japanese Patent Laid-Open No. 2006-91405), a first lens, a prism, a second lens, and a third lens are arranged from a subject side, and the second lens and the third lens are held by a thin lens holding frame made of metal. A first opening through which a first optical axis L1 passes and a second opening through which a second optical axis L2 passes are formed in a prism holding frame. A section between the lower end of the first opening and the front end of the second opening is cut out. A prism is placed on a prism holding pedestal, and the lens holding frame is incorporated in the second opening. The first lens is fixed by a first lens fixing frame. The outer periphery of the lens holding frame is exposed from an end on the front side of the second opening, and an edge of the first lens abuts against the outer periphery of the exposed lens holding frame.

However, the lens barrel disclosed in the Japanese patent application (Japanese Patent Laid-Open No. 2006-91405) adopts a configuration in which a lens group of image surface side abut against the prism only via a sheet material, and a lens group of subject side abut against the prism holding frame. It is thus difficult to keep the optical performance high.

Therefore, there has conventionally been a demand for a lens apparatus which can be reduced in size and weight and has high optical performance.

### SUMMARY OF THE INVENTION

Under the circumstances, the present inventors have made an intense study in order to solve the above-described problem. Adoption of a lens apparatus to be described below and an image pickup apparatus using the lens apparatus has led to the solution of the problem. The outline of the present invention will be described below.

A lens apparatus according to the present invention is a lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side, wherein the lens group of subject side is fixed to the entrance surface of the prism.

A lens apparatus according to the present invention is a lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side, wherein the lens group of image pickup surface side is fixed to the exit surface of the prism.

A lens apparatus according to the present invention is a lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side, wherein the lens group of subject side is fixed to the entrance surface of the prism, and the lens group of image pickup surface side is fixed to the exit surface of the prism.

In the lens apparatus according to the present invention, the prism is preferably arranged such that the exit surface and the reflection surface of the prism abut against the prism holder.

In the lens apparatus according to the present invention, a surface shape of the lens constituting the lens group of subject side which faces to the prism is preferable to be concave.

In the lens apparatus according to the present invention, a surface shape of the lens constituting the lens group of image pickup surface side which faces to the prism is preferable to be concave.

An image pickup apparatus according to the present invention uses the lens apparatus.

### ADVANTAGES OF THE INVENTION

In a lens apparatus according to the present invention, a lens group of subject side arranged on the side of an entrance surface on which a light beam comes incident and/or a lens group of image pickup surface side arranged on the side of an exit surface from which a light beam is emitted are/is fixed to a prism incorporated in a holding frame. Accordingly, the distance between the lens group of subject side and the prism and/or the distance between the lens group of image pickup surface side and the prism can be shortened. This achieves a further reduction in the size of the lens apparatus and makes it possible to more accurately position the lens groups. Use of the lens apparatus according to the present invention in an image pickup apparatus makes it possible to provide a small-sized, fine-quality image pickup apparatus.

### BRIEF DESCRIPTION OF THE DRAWINGS

FIG. 1 is an external perspective view showing an embodiment of a lens apparatus according to the present invention from the side of the front;

FIG. 2 is an external perspective view showing the embodiment of the lens apparatus according to the present invention from the side of the back;

FIG. 3 is a rear view of the lens apparatus according to the present invention;

FIG. 4 is a sectional view taken along line A-A′ of the lens apparatus shown in FIG. 3;

FIG. 5 is a sectional view taken along line B-B′ of the lens apparatus shown in FIG. 3;

FIG. 6 is a main part sectional view related to a lens and a prism taken along line A-A′ of the lens apparatus shown in FIG. 3; and

FIG. 7 is a view showing a preferable dimensional condition for a prism diagonal line length and a lens effective diameter.

### DETAILED DESCRIPTION OF THE PREFERRED EMBODIMENT (S)

A lens apparatus according to the present invention includes a prism having a reflection surface which bends an optical axis almost at a right angle, a prism holder which holds the prism, a lens group of subject side, and a lens group of image pickup surface side. The lens apparatus according to the present invention is preferably configured such that the lens group of subject side is fixed to an entrance surface of the prism and/or the lens group of image pickup surface side is fixed to an exit surface of the prism. The above-described configuration in which the lens group of subject side abut against and is fixed to the entrance surface of the prism, and the lens group of image pickup surface side abut against and is fixed to the exit surface of the prism allows an improvement in the angular accuracy of the optical axis of each lens group abutting against the prism.

Note that each of a combination of the prism and the lens group of image pickup surface side and a combination of the prism and the lens group of subject side may be fixed via a sheet-like light blocking mask. Fixation of each lens group to the prism via the light blocking mask makes it possible to minimize a reduction in optical axis angular accuracy, prevent the occurrence of a ghost, and provide a lens apparatus which is suitable for a size reduction and includes a bending optical system.

This embodiment has as its object to provide a lens apparatus which can be reduced in size and weight and has high optical performance. A configuration for achieving the object will be described in detail below with reference to the drawings.

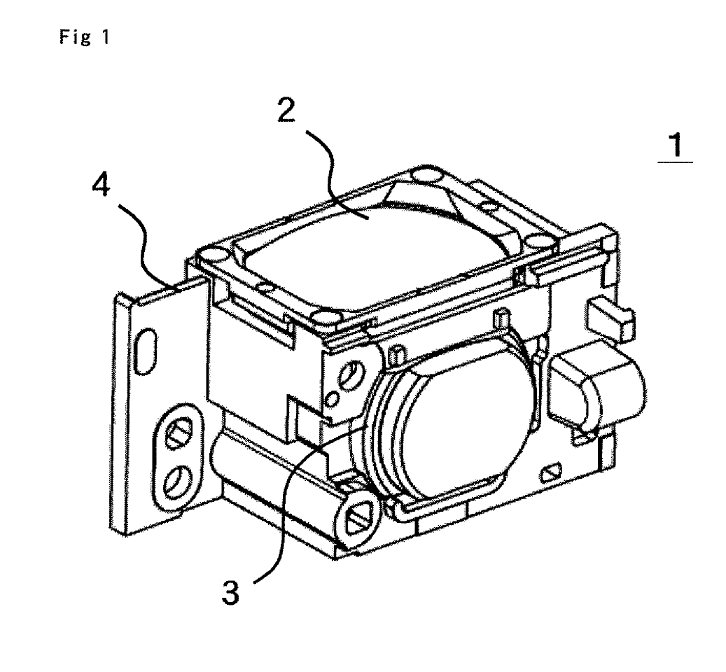

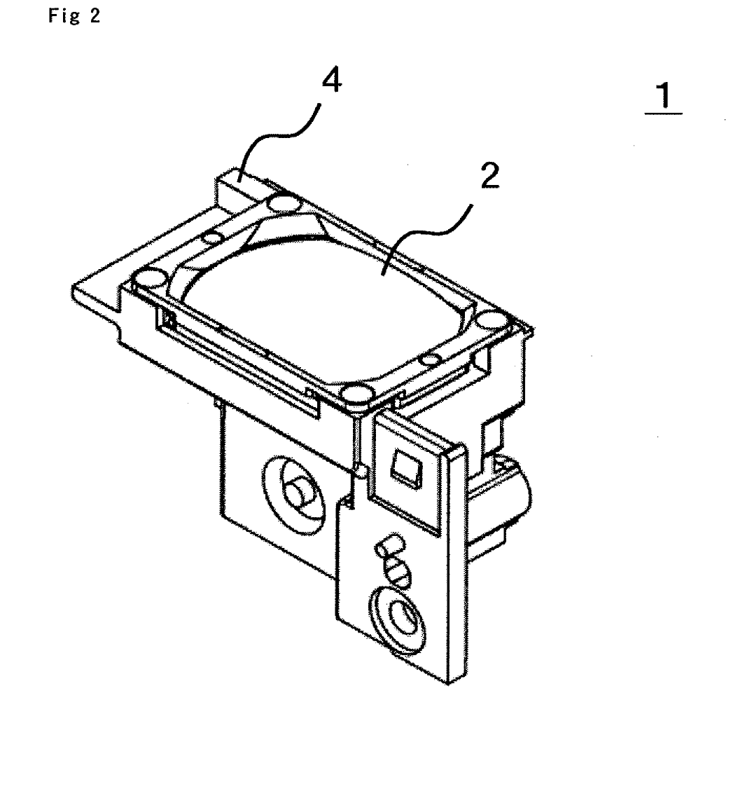

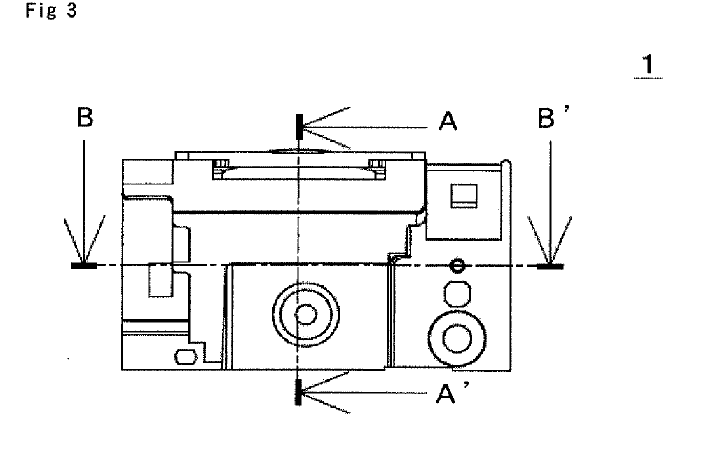

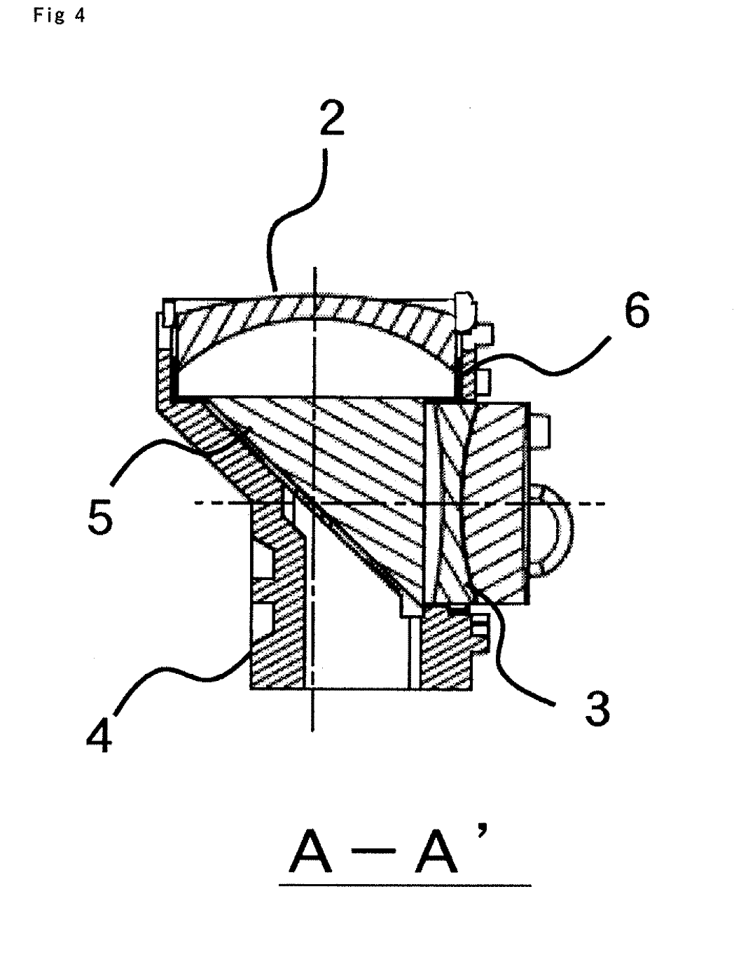

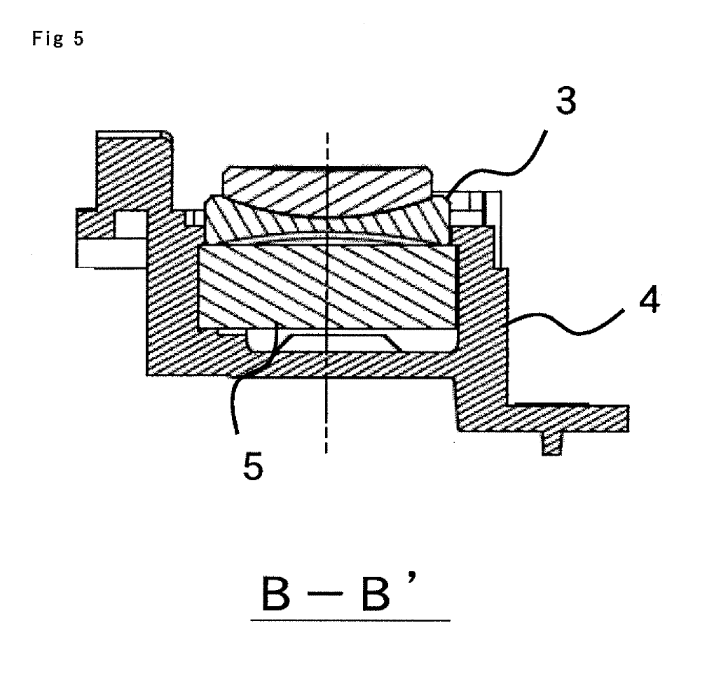

FIG. 1 is a perspective view showing an embodiment of a lens apparatus 1 according to the present invention from the side of the front on which an image pickup surface-side lens 3 is arranged. FIG. 1 shows a state in which a subject-side lens 2 and the image pickup surface-side lens 3 are arranged to be fixed to a prism holder 4. FIG. 2 is a perspective view showing the embodiment of the lens apparatus 1 according to the present invention from the side of the back. FIG. 2 shows a state in which the subject-side lens 2 is arranged to be fixed to the prism holder 4. FIG. 3 shows a rear view of the lens apparatus 1 according to the present invention. FIG. 4 shows a sectional view taken along line A-A′ of the lens apparatus in FIG. 3, and FIG. 5 shows a sectional view taken along line B-B′ of the lens apparatus. A description of FIGS. 4 and 5 will be given below.

FIG. 4 shows a state in which the subject-side lens 2 is arranged to be fixed on the side of an entrance surface of a prism 5 which is arranged to abut against the prism holder 4 while the image pickup surface-side lens 3 is arranged to be fixed on the side of an exit surface of the prism 5. Assume in FIG. 4 that a X optical axis is an optical axis which is perpendicular to an image pickup surface, and a Y optical axis is an optical axis which is bent almost at a right angle by a reflection surface of the prism. A lens group of image pickup surface side is arranged to abut against the prism in the direction of the X optical axis of the prism, and a lens group of subject side is fixedly arranged in the direction of the Y optical axis of the prism. Arranging the subject-side lens to abut against the prism with no member between the prism and the subject-side lens at this time allows a further improvement in the angular accuracy of the optical axis. However, a light blocking mask 6 may be arranged between the subject-side lens 2 and the prism 5, as shown in FIG. 4. Arrangement of the light blocking mask between the lens and the prism blocks a light beam other than an effective light beam for the prism and allows prevention of the occurrence of a ghost or a flare which is produced when intense light incident at the time of photography is repeatedly reflected. Preparing the light blocking masks 6 with different thicknesses and switching among the light blocking masks 6 allow fine adjustment of the optical performance.

FIG. 5 shows a state in which the prism 5 is arranged to abut against the prism holder 4, and the image pickup surface-side lens 3 is arranged to abut against the prism 5. As shown in FIGS. 4 and 5, the prism 5 is positioned in the X optical axis direction by abutting against the prism holder 4 on the side of the exit surface of the prism 5 and is positioned in the Y optical axis direction by abutting against the prism holder 4 on the side of the reflection surface of the prism 5 while the positions of the optical axes are accurately held. If the image pickup surface-side lens 3 is held by the prism holder 4 at this time such that its diameter fits in the prism holder 4, the axis of the lens can be aligned. Positioning of a guide pole and a base plate by the prism holder 4 makes it possible to align the axis of a lens to be arranged subsequent to the image pickup surface-side lens 3. As described above, the prism 5 and each of the subject-side lens 2 and the image pickup surface-side lens 3 are arranged to be fixed. This makes it possible to prevent a reduction in the angular accuracy of each optical axis.

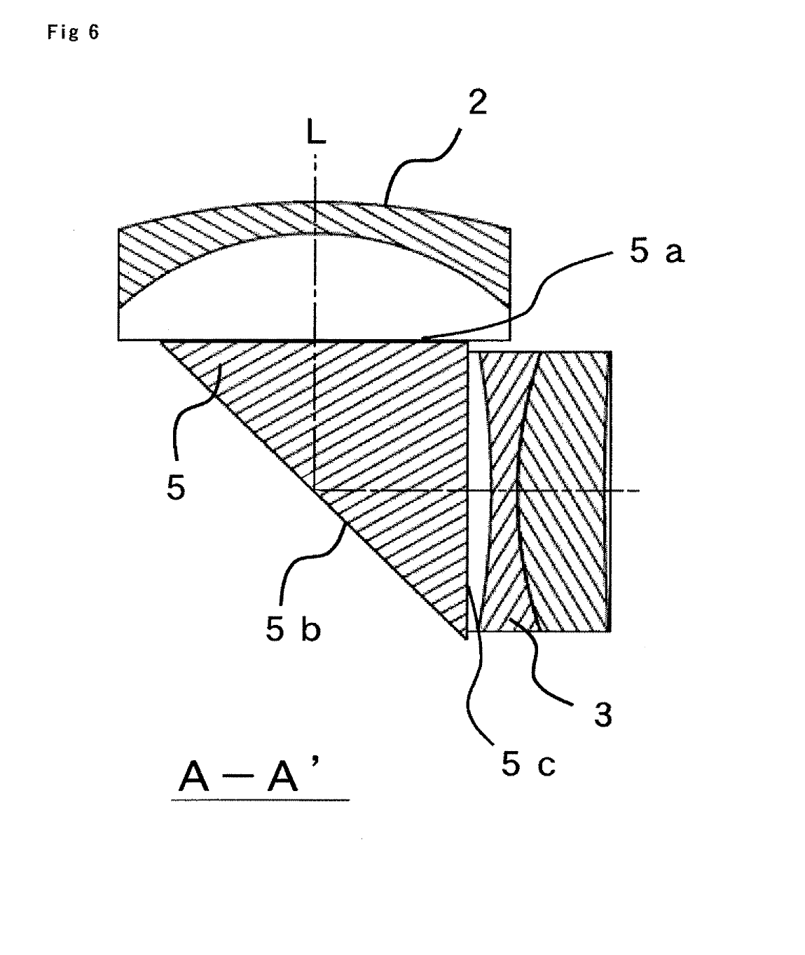

FIG. 6 is a main part sectional view related to arrangement of the prism 5, the subject-side lens 2, and the image pickup surface-side lens 3 according to the present invention, taken along line A-A′ in FIG. 3. As shown in FIG. 6, the surface shape of the image pickup surface-side lens 3 which faces to the prism is concave. Since a part outside the effective diameter of the image pickup surface-side lens 3 has been centered and edged with respect to a surface orthogonal to an optical axis L, a centering and edging surface can abut against the exit surface of the prism 5. As shown in FIG. 6, the surface shape of the subject-side lens 2 which faces to the prism is also concave. Since a part outside the effective diameter of the subject-side lens 2 has been centered and edged with respect to a surface orthogonal to the optical axis L, a centering and edging surface can abut against the entrance surface of the prism 5. As described above, the prism 5 and each of the subject-side lens 2 and the image pickup surface-side lens 3 or the prism 5 and the subject-side lens 2 or the image pickup surface-side lens 3 are arranged to abut against each other without any member between the optical elements. This makes it possible to keep the angular accuracy of the optical axis L at a high level.

The surface shapes of the subject-side lens 2 and the image pickup surface-side lens 3 which face to the prism are both concave. Accordingly, when the lenses 2 and 3 are fixed to the prism 5, it is possible to achieve the advantage that the lenses 2 and 3 can be easily brought into parallelism with the entrance surface and the exit surface of the prism and the advantage that the accuracy of the air spacing between each of the lenses 2 and 3 and the prism 5 can be easily ensured. These advantages eliminate the need to take variations in parts accuracy into consideration in the context of the prism and the lenses.

As shown in FIG. 6, the prism 5 has a surface 5b as a reflection surface, allows a light beam on the optical axis L to enter from an entrance surface 5a which is a flat surface, reflects and deflects the light beam at an angle of 90°, and emits the light beam from an exit surface 5c. Note that an angle at which a light beam is reflected by the reflection surface 5b need not be 90°.

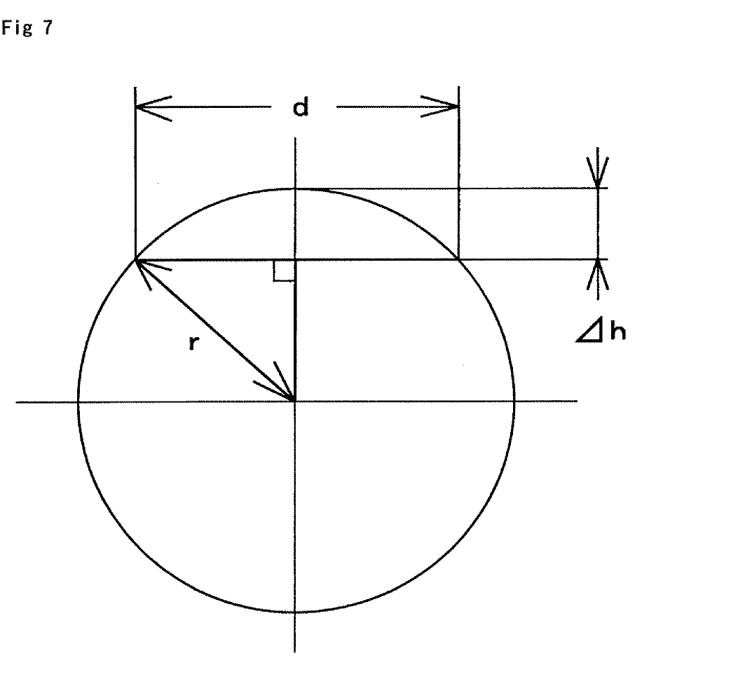

A preferable dimensional condition for a concave lens and a prism when a concave lens surface of the concave lens is fixed to the prism will be described below. A preferable dimensional condition when a concave lens is fixed to a flat surface of a prism can be calculated by letting d be a lens effective diameter, r be a lens curvature, Δh be a lens height, and D be a prism diagonal line length in the view shown in FIG. 7.

A triangle is present in a circle in FIG. 7. If the Pythagorean theorem is applied to the triangle with a focus on the fact, a formula given by Formula 1 holds.

$${( \frac{d}{2} )}^{2} + {( r - Δ h )}^{2} = {r}^{2} \qquad [ Formula 1 ]$$

If Formula 1 is expanded and is reorganized with respect the lens effective diameter d, Formula 2 is derived.

d=\sqrt{4Δh(2r−Δh)} [Formula 2]

If the length d of the lens effective diameter exceeds the prism diagonal line length D, it is impossible to cause the lens to directly abut against the prism. Additionally, a light region in which light is not bent by the prism may occur. The effective diameter d is preferably not more than the prism diagonal line length D. Accordingly, the prism diagonal line length D needs to satisfy D≧d. If Formula 2 is substituted into d in the inequality, Formula 3 is derived.

D≧=\sqrt{4Δh(2r−Δh)} [Formula 3]

Selecting a combination of a lens and a prism sized to satisfy the condition indicated by Formula 3 makes it possible to cause the lens to directly abut against the prism and prevent the occurrence of a light region in which light is not bent by the prism. Additionally, use of Formula 2 allows derivation of the relationship among a lens curvature, a lens effective diameter, and a lens thickness.

As has been described above, according to a lens apparatus according to the present invention, since optical elements are arranged to abut against each other without any member between them, and the angular accuracy of a bent optical axis can be kept high, a reduction in the size of an image pickup apparatus is achieved, and a lens apparatus excellent in lens driving accuracy can be provided.

### INDUSTRIAL APPLICABILITY

Adoption of a lens apparatus according to the present invention achieves a size reduction and makes it possible to provide an image pickup apparatus including a high-accuracy bending optical system.

What is claimed is:

1. A lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side,
wherein the lens group of subject side is fixed to the entrance surface of the prism.

2. The lens apparatus according to claim 1
wherein the prism is arranged such that the exit surface and the reflection surface of the prism abut against the prism holder.

3. The lens apparatus according to claim 1,
wherein a surface shape of the lens constituting the lens group of subject side which faces to the prism is concave.

4. An image pickup apparatus using a lens apparatus according to claim 1.

5. A lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side,
wherein the lens group of image pickup surface side is fixed to the exit surface of the prism.

6. The lens apparatus according to claim 5,
wherein the prism is arranged such that the exit surface and the reflection surface of the prism abut against the prism holder.

7. The lens apparatus according to claim 5,
wherein a surface shape of the lens constituting the lens group of image pickup surface side which faces to the prism is concave.

8. An image pickup apparatus using a lens apparatus according to claim 5.

9. A lens apparatus comprising a prism having an entrance surface which receives a light beam incident from a subject side, a reflection surface which deflects a light beam incident from the entrance surface, and an exit surface which emits a light beam deflected by the reflection surface toward an image pickup surface side, a prism holder which holds the prism, a lens group of subject side, and a lens group of image pickup surface side,
wherein the lens group of subject side is fixed to the entrance surface of the prism, and the lens group of image pickup surface side is fixed to the exit surface of the prism.

10. The lens apparatus according to claim 9,
wherein the prism is arranged such that the exit surface and the reflection surface of the prism abut against the prism holder.

11. The lens apparatus according to claim 9,
wherein a surface shape of the lens constituting the lens group of subject side which faces to the prism is concave.

12. The lens apparatus according to claim 9,
wherein a surface shape of the lens constituting the lens group of image pickup surface side which faces to the prism is concave.

13. An image pickup apparatus using a lens apparatus according to claim 9.
